(19) United States
(12) Patent Application Publication
(10) Pub. No.: US 2008/0105742 A1
(43) Pub. Date: May 8, 2008

(54) DEVICE AND METHOD OF ELECTRONIC VOTING USING MOBILE TERMINAL

(76) Inventors: Keonwoo KIM, Daejeon-city (KR); Tae Jun PARK, Seoul (KR); Do Won HONG, Daejeon-city (KR); Kyo Il CHUNG, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/867,227

(22) Filed: Oct. 4, 2007

(30) Foreign Application Priority Data
Nov. 6, 2006 (KR) 10-2006-0108908

(51) Int. Cl. G06K 17/00

(52) U.S. Cl. 235/386

(57) ABSTRACT

Provided are a device for and a method of electronic voting (e-voting) using a wireless terminal. The e-voting device comprises: a voter identity verifying unit which verifies a voter can be allowed to vote based on a certificate of the voter received from a wireless terminal of the voter over a mobile communication network; an encryption key management unit which creates an encryption key for encrypting the content of voting and transmits the encryption key to the wireless terminal; a vote information providing unit which provides vote information containing a list of possible voting selections to the wireless terminal; and a voting selection storing unit which decrypts the encrypted content of voting that a personal identification information of the voter has been deleted and stores its result. The present invention allows a voter to cast his/her vote in a simple and convenient way without time and travel demands, thereby increasing the voting rate, and also ensuring secrecy and anonymity.

### CROSS-REFERENCE TO RELATED PATENT APPLICATIONS

This application claims the priority of Korean Patent Application No. 10-2006-0108908, filed on Nov. 6, 2006, in the Korean Intellectual Property Office, the disclosure of which is incorporated herein in its entirety by reference.

### BACKGROUND OF THE INVENTION

1. Field of the Invention

The present invention relates to a device for and method of electronic voting using a mobile terminal, and more particularly, to a device and a method that allow a subscriber of a mobile communication service who has the right to vote to cast his/her vote using his/her mobile terminal over a mobile communication network of a mobile communication service provider, the mobile communication network being engaged with an electronic voting device of a governmental agency such as the Central Election Management Committee.

The present invention was supported by the Information Technology (IT) Research & Development (R&D) program of the Ministry of Information and Communication (MIC) [Project management number: 2006-S-008-01, Project title: Study on enhancement of authentication and security service in the telecommunication system].

2. Description of the Related Art

In the existing method to select a candidate in the presidential election, elections of National Assembly, or local elections, voters go to designated polling places and have to be identified to cast their votes, the votes are counted by hand, and thus a significant amount of time and cost are consumed by voting and the counting of votes.

Moreover, since voters have to go to designated polling place to cast their votes, there are travel demands on the voters which may cause a decrease in the voting rate. An electronic voting (e-voting) method adopting a touch screen which allows a voter to select a candidate or an option displayed on a screen in person has advantages in that the voter can cast his/her vote regardless of his/her designated polling place, but in this case, the voter is still required to go to a polling place to vote.

Meanwhile, in an e-voting method using the Internet, voters do not have to go to a polling place in person. But Internet-accessible terminals are required to vote and there is a difficulty in engaging an e-voting device with an Internet service providing system, since there are a lot of Internet service providers. Furthermore, information about a personal ID might be leaked in the course of accessing to the Internet. Thus, it is difficult to ensure the secrecy of voting.

Furthermore, if a voter is not in a voting district or is in a place where it is not possible to access the Internet, the voter is not able to cast his/her vote.

### SUMMARY OF THE INVENTION

The present invention provides a device and method that allow a user to be identified using a certificate without additionally registering to electronically vote when the user votes using his/her mobile phone.

The present invention also provides a device and method that ensure secrecy of the vote by encrypting a voter's ballot and deleting identification information of a user of a mobile phone used for the vote.

According to an aspect of the present invention, there is provided an electronic voting (e-voting) device comprising: a voter identity verifying unit which verifies a voter can be allowed to vote based on a certificate of the voter received from a wireless terminal of the voter over a mobile communication network; an encryption key management unit which creates an encryption key for encrypting the content of voting and transmits the encryption key to the wireless terminal; a vote information providing unit which provides vote information containing a list of possible voting selections to the wireless terminal; and a voting selection storing unit which decrypts the encrypted content of voting that a personal identification information of the voter has been deleted and stores its result.

According to another aspect of the present invention, there is provided an e-voting method comprising: verifying a voter can be allowed to vote based on a certificate of the voter received from a wireless terminal of the voter over a mobile communication network; creating an encryption key for encrypting a content of voting and sending the encryption key to the wireless terminal; sending vote information containing a list of possible voting selections to the wireless terminal; and decrypting the encrypted content of voting which contains a voting selection that the voter made based on the vote information and from which a personal identification information of the voter has been deleted, and storing the decrypted content of voting.

According to still another aspect of the present invention, there is provided a wireless terminal which is connected to an e-voting device over a mobile communication network, the wireless terminal comprising: a certificate management unit which stores a certificate of a voter containing a personal identification number and sends the certificate together with a password for the certificate which the voter has been requested to input in response to a voter verification request of the e-voting device; a vote information receiving unit which receives vote information including an encryption key and a list of possible voting selections from the e-voting device; and an encryption unit which encrypts the content of voting including a voting selection that a voter made based on the vote information using the encryption key and sends the encrypted content of voting to the e-voting device.

According to yet another aspect of the present invention, there is provided a method of e-voting using a wireless terminal which is connected to an e-voting device over a mobile communication network, the method comprising: sending a certificate of a voter containing a personal identification number together with a password for the certificate which the voter has been requested to input in response to a voter verification request of the e-voting device; receiving vote information which includes an encryption key and a list of possible voting selections from the e-voting device; and encrypting the content of voting which includes a voting selection that a voter made based on the vote information, and sending the content of voting to the e-voting device.

According to another aspect of the present invention, there is provided a mobile communication server which connects a wireless terminal and an e-voting device over a mobile communication network, the mobile communication server comprising: a sending/receiving unit which receives vote information containing an encryption key and a list of possible voting selections from the e-voting device and sends the vote information to the wireless terminal, and receives, from the wireless terminal, an encrypted content of voting which includes a voting selection that a voter made based on the vote information, and sends the encrypted content of voting to the e-voting device; and a personal identification information deleting unit which deletes personal identification information of the voter, who cast a vote using the wireless terminal, before sending the encrypted content of voting to the e-voting device.

According to another aspect of the present invention, there is provided a method of e-voting using a mobile communication server which connects a wireless terminal and an e-voting device each other over a mobile communication network, the method comprising: receiving vote information containing an encryption key and a list of possible voting selections from the e-voting device and sending the vote information to the wireless terminal; receiving an encrypted content of voting which includes a voting selection that a voter made based on the vote information from the wireless terminal; deleting personal identification information of the voter, who cast his/her vote using the wireless terminal, from the encrypted content of voting; and sending the encrypted content of voting from which the personal identification information has been deleted to the e-voting device.

According to another aspect of the present invention, there is provided a system for e-voting over a mobile communication network, the system comprising: a wireless terminal which encrypts a content of voting, the content of voting including a voting selection that a voter made based on received vote information, using an encryption key and sends the content of voting to a mobile communication server; the mobile communication server which deletes personal identification information of the voter from the encrypted content of voting; and an e-voting device which verifies the voter can be allowed to vote using a certificate of the voter and a password for the certificate which the voter has been requested to input which are received from the wireless terminal, sends the vote information and the encryption key to the wireless terminal, decrypts the encrypted content of voting from which the personal identification information has been deleted, and refuses an attempt by the voter to vote more than once.

### BRIEF DESCRIPTION OF THE DRAWINGS

The above and other features and advantages of the present invention will become more apparent by describing in detail exemplary embodiments thereof with reference to the attached drawings in which:

FIG. 1 is an illustration of an electronic voting (e-voting) system for e-voting over a mobile communication network according to an embodiment of the present invention;

FIG. 2 is a block diagram that schematically shows a structure of the e-voting system illustrated in FIG. 1;

FIG. 3 is a table showing an example of secret keys generated in an encryption key management unit of an e-voting device illustrated in FIG. 2;

FIG. 4 illustrates an example of encryption and decryption using a secret key according to an embodiment of the present invention;

FIG. 5 illustrates an example of encryption and decryption using a public key according to an embodiment of the present invention;

FIG. 6 illustrates procedures of e-voting between an e-voting device and a voter according to an embodiment of the present invention;

FIG. 7 is a flowchart showing the procedure of e-voting in an e-voting device according to an embodiment of the present invention;

FIG. 8 is a flowchart showing the procedure of e-voting in a wireless terminal according to an embodiment of the present invention; and

FIG. 9 is a flowchart showing the procedure of e-voting in a mobile communication server according to an embodiment of the present invention.

### DETAILED DESCRIPTION OF THE INVENTION

The present invention will now be described more fully with reference to the accompanying drawings, in which exemplary embodiments of the invention are shown. Like reference numerals in the drawings, even in different drawings, denote like elements. Hereinafter, in describing the present invention, detailed descriptions of relevant functions or structures well-known to those skilled in the art will be omitted when it is considered that the descriptions obscure the point of the present invention.

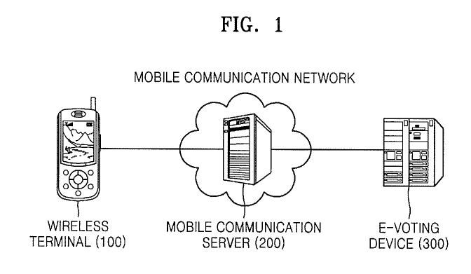

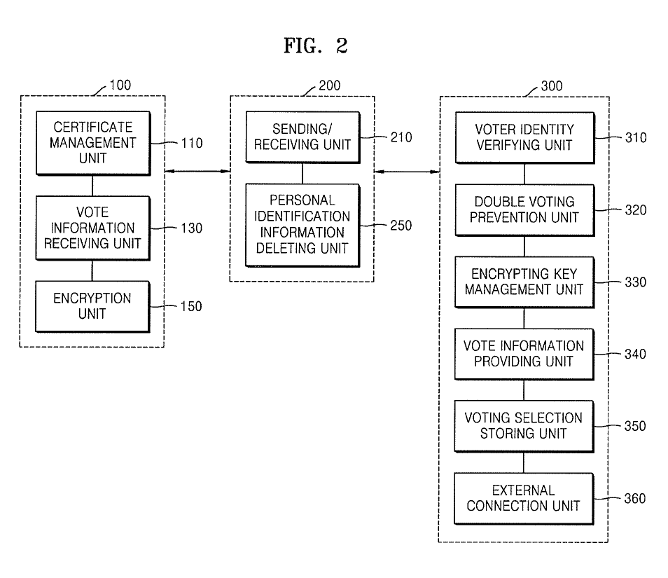

FIG. 1 is an illustration of an electronic voting (e-voting) system for e-voting over a mobile communication network according to an embodiment of the present invention, and FIG. 2 is a block diagram that schematically shows a structure of the e-voting system illustrated in FIG. 1.

Referring to FIG. 1, the e-voting system includes a wireless terminal 100, a mobile communication server 200, and an e-voting device 300.

The wireless terminal 100 encrypts the content of voting, which includes a voting selection of a voter who cast his/her vote based on displayed vote information, using an encryption key, and transmits the encrypted content to the mobile communication server 200. The wireless terminal 100 may be a mobile wireless communication device such as a mobile phone, a personal digital assistant, or the like which can send and receive text messages or multimedia messages.

The mobile communication server 200 removes personal identification information of the voter who cast the vote using the mobile terminal 100 from the encrypted content of voting, and then transmits the content to the e-voting device 300. Therefore, the e-voting device 300 receives only content of voting and the removed personal identification information and is not able to identify who cast the vote.

With regards to security, the e-voting device 300 receives a certificate and a password to verify the voter's identity, and transmits the vote information and an encryption key to the wireless terminal 100 so that the wireless terminal 100 can encrypt the content of voting using the encryption key after the voter casts his/her vote based on the vote information. Moreover, the e-voting device 300 receives the content of voting, which is encrypted and then the personal identification information is removed from it, from the mobile communication server 200, decrypts the content of voting and stores the content of voting. Furthermore, the e-voting device 300 refuses an attempt to re-vote by a voter who has already voted.

Hereinafter, structures of the wireless terminal 100, the mobile communication server 200, and the e-voting device 300 will be described in detail with reference to FIG. 2.

The wireless terminal 100 includes a certificate management unit 110, a vote information receiving unit 130, and an encryption unit 150.

The certificate management unit 110 stores a certificate which contains a personal identification number and is issued by a certification authority, and transmits the certificate to the e-voting device 300 in response to a request of verifying the identity of a voter. In this case, the certificate management unit 110 may request the voter who is the user of the wireless terminal 100 to input a password before transmitting the certificate, thereby checking if the voter is authorized to use the certificate and thus preventing others from using the certificate fraudulently. The wireless device 100 may have a structure that can recognize the certificate which is stored in an additional storage device in advance.

The vote information receiving unit 130 receives an encryption key and vote information including candidates from the e-voting device 300. The voter cast his/her vote based on the vote information. The vote information may be information that is customized to the voter based on the personal identification number of the certificate sent from the wireless device 100. Alternatively, if an election has different candidates for different locations, for example, for councilors or district representatives, the vote information may include all candidates of every locality. In this case, the voter may select local candidate group information from the vote information and cast the vote based on the information.

The encryption unit 150 encrypts the content of voting including the voter's voting selection using the encryption key and transmits the encrypted content of voting to the e-voting device 300, thereby ensuring the vote is secret. In the case of using a symmetry key based method, a secret key which is encrypted using a private key and a public key operation of the wireless terminal 100 is decrypted and extracted, and this secret key may be used as the encryption key for the content of voting. Alternatively, in the case of using a public key based method, the content of voting is encrypted using a public key received from the e-voting device 300 and then the encrypted content of voting is transmitted to the e-voting device 300 via a mobile communication network.

The e-voting device 300 includes a voter identity verifying unit 310, a double vote prevention unit 320, an encryption management unit 330, a vote information providing unit 340, a voting selection storing unit 350, and an external connection unit 360.

The voter identity verifying unit 310 verifies the voter's identity and decides the voter can proceed to vote based on the certificate received from the mobile terminal 100 of the voter over the mobile communication network. The voter identity verifying unit 310 issues a request to verify the identity of the voter to the wireless terminal 100 and receives the certificate from the wireless terminal 100 in response to the request, and thereby the voter identity verifying unit 310 verifies the voter's identity and then verifies the voter can be allowed to vote. The voter identity verifying unit 310 may verify the identity of the voter directly or verify the identity of the voter in conjunction with a certification authority through the external connection unit 360 that will be described later.

To verify the identity of the voter using the certificate, the voter has to be issued with a wireless certificate before e-voting. The certificate can be issued in an environment where a wireless public key infrastructure is established, and can be used for e-finance transactions and e-commerce as well as e-voting. The certificate includes a personal identification number (a resident registration number, a social security number, or the like) of a user, which allows the voter to select candidates according to the voter's address. The wireless certificate may be issued by a certification authority which is connected to the external connection unit 360 of the e-voting device 300 or by an individual certification authority which has no connection with the e-voting device 300.

To prevent double voting through a mobile phone after the voter completes voting, the double vote prevention unit 320 refuses an attempt by the voter to verify his/her identity again as long as the voter has already been verified by connecting to the e-voting device 300. Furthermore, to prevent the voter from voting more than once by going to the polling place after completing voting using his/her mobile phone or from voting more than once by voting using his/her mobile phone after completing voting with a ballot paper at a polling place, the e-voting device is electronically engaged with the electoral register to prevent double-voting.

The encryption key management unit 330 creates the encryption key for encrypting the content of voting and transmits it to the wireless terminal 100. In the e-voting system it is required to encrypt the voting content in order to protect the secrecy of the vote from devices such as a mobile communication server excluding the e-voting device 300.

The encryption key management unit 330 generates the secret key and a key identifier and transmits them to the wireless terminal 100 when employing a secret key type encryption, or transmits a public key of the e-voting device 300 to the wireless terminal 100 when employing a public key type encryption. If the secret key is generated for each voter, a particular secret key is required for a certain voter when the secret key is to be used to perform decryption, and accordingly the anonymity of the voter regarding the voting content is violated. Thus, to avoid this, the encryption keys may be generated on a time period basis and then the same encryption key may be assigned to voters who access at a certain time period, or the same encryption key may be assigned to voters in the same district by checking the address of the voters from their certificates and the same encryption key identifier may be used for identifying the encryption key.

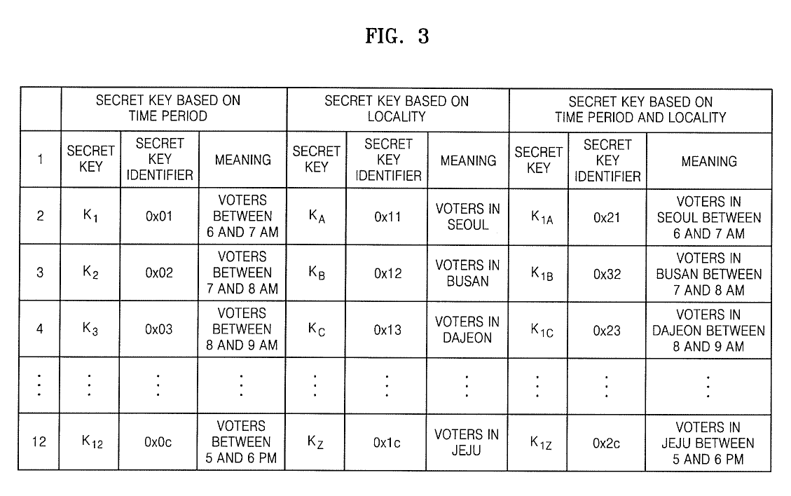

FIG. 3 is a table showing an example of encryption keys that may be generated by the encryption key management unit 330. Referring to FIG. 3, the encryption keys can be generated depending on time periods, localities, or time periods and localities. In a similar way to the above, encryption keys may be generated by creating several encryption key groups. When the secret key and key identifier are transmitted, they are encrypted using a public key of the voter to avoid disclosing information of the secret key and key identifier. In the case of a public key encryption method, the public key of the e-voting device is transmitted.

The vote information providing unit 340 transmits the list of possible voting selections and/or the vote information including the candidates to the wireless terminal 100. At this time, the vote information including a list of some candidates of certain district may be transmitted to voters in the same district according to addresses obtained from the personal identification numbers. Alternatively, the vote information including a list of all candidates of the whole country may be provided to voters, and then the voter may select candidate group information of the corresponding district. In this case, checking of a user's selection may be added to prevent an error in which the voter may select candidate group information of another district.

The voting selection storing unit 350 stores the content of voting encrypted in the wireless terminal 100, and decrypts the content of voting after the voting time has passed. The content of voting stored in the voting selection storing unit 350 is generated by removing the personal identification information of the voter from the content of voting, which contains information about the voter's voting selection and is encrypted in the wireless terminal 100, using the mobile communication server 200. The voting selection storing unit 350 receives encrypted content of voting and information about key identifiers from the mobile communication server 200 and stores them, and decrypts the content of voting using the information about key identifier and encryption key and stores the decrypted result to count votes when the vote is complete.

In the case of a secret key type encryption, secret keys are extracted based on time periods and/or localities in the course of decryption, and in the case of a public key type encryption, a private key of the e-voting device 300 may be used for decryption.

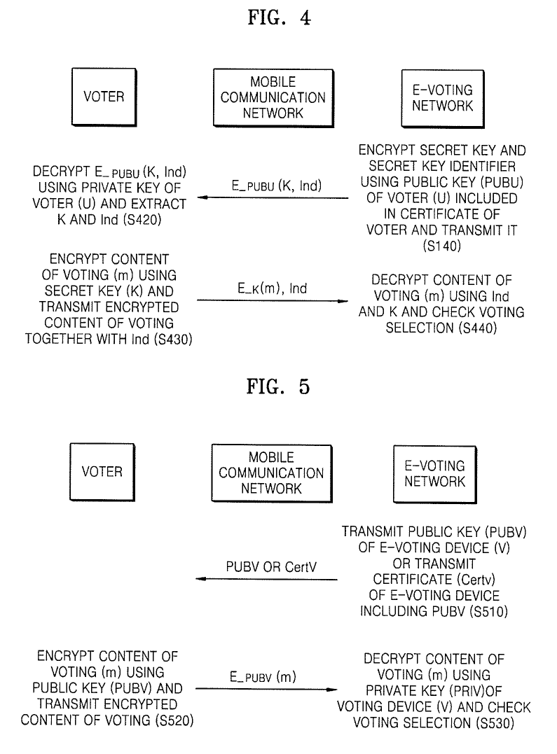

FIG. 4 illustrates an example of encryption and decryption using a secret key according to an embodiment of the present invention, and FIG. 5 illustrates an example of encryption and decryption using a public key according to an embodiment of the present invention.

Referring to FIG. 4, the e-voting device 300 encrypts the secret key K and a secret key identifier Ind using a public key PUBU of a voter U included in a certificate of the voter U and transmits them to the mobile terminal 100 (S410).

The voter U receives the encrypted information E_{—PUBU}(K, Ind) and decrypts it, using a private key of the voter U, and extracts the secret key K and the secret key identifier Ind (S420).

The wireless terminal 100 of the voter U encrypts the content of voting m using the secret key K, and transmits the encrypted content E_{—K}(m) together with the key identifier Ind to the e-voting device 300 (S430).

The e-voting device 300 decrypts the encrypted content of voting E_{—K}(m), which has been transmitted from the wireless terminal 100, using the secret key K and the key identifier Ind, then checks the voter's selection (S440).

Referring to FIG. 5, the e-voting device 300 transmits its public key PUBV or its certificate CertV containing the public key PUBV to the wireless terminal 100 (S510).

The wireless terminal 100 receives the public key PUBV, encrypts the content of voting m using the public key PUBV and transmits the encrypted content E_{—PUBV}(m) to the e-voting device 300 (S520).

The e-voting device 300 decrypts the encrypted content of voting E_{—PUBV}(m), which has been transmitted from the wireless terminal 100, using a private key PRIV of the e-voting device 300, and checks the voter's selection (S530).

Referring to FIG. 2 again, the external connection unit 360 issues the certificate of the voter to the wireless terminal 100 or verifies the identity of the voter in conjunction with the certification authority which issues the certificate including a personal identification number of the voter.

The mobile communication server 200 acts to connect the wireless terminal 100 and the e-voting device 300 through the mobile communication network to transmit information therebetween.

The mobile communication server 200 includes a sending/receiving unit 210, and a personal identification information deleting unit 250.

The sending/receiving unit 210 receives the vote information including the encryption key and list of possible voting selections from the e-voting device 300, and transmits it to the wireless terminal 100. Also, the sending/receiving unit 210 receives the encrypted content of voting, which includes the voting selection that the voter cast based on the vote information, from the wireless terminal 100, and transmits the content to the e-voting device 300.

The personal identification information deleting unit 250 deletes personal identification information of the voter who uses the mobile terminal 100 to vote from the content of voting before the sending/receiving unit 210 sends the encrypted content of voting to the e-voting device 300, and consequently the sending/receiving unit 210 sends only the encrypted content of voting without the personal identification information, and secret key identifier. Thus, the e-voting device 300 cannot know relation between the voter and the content of voting, thereby allowing the anonymity and secrecy.

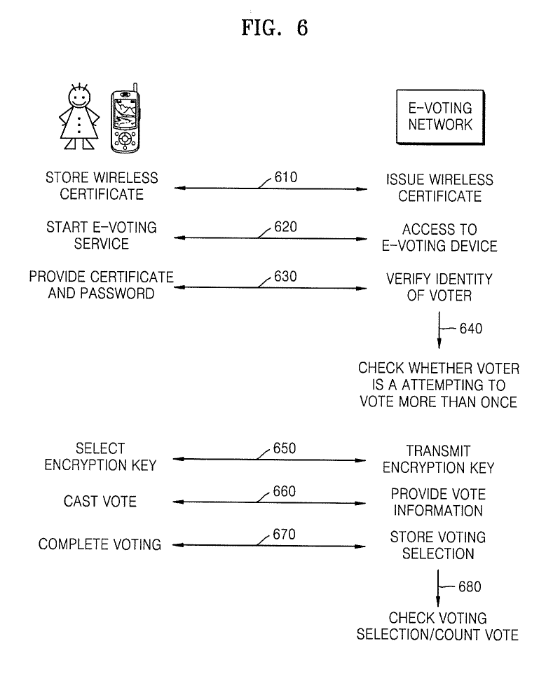

FIG. 6 illustrates the procedure of e-voting between an e-voting device and a voter according to an embodiment of the present invention.

The voter has to be issued with a wireless certificate before commencing voting (S610). The wireless certificate may be issued by a certification authority connected with an external connection unit of the e-voting device, or by an individual certification authority which has no connection with the e-voting device.

The voter connects a wireless terminal to the e-voting device over a mobile communication network (S620), and an e-voting connection device (not shown) takes charge of information transmission from/to the mobile communication network.

The e-voting device requires the wireless device to verify the identity of the voter, and the voter sends the certificate to identify himself/herself (S630).

When the identity of the voter is verified and the voter is given the right to vote, the e-voting device checks if the voter is re-accessing the e-voting device after casting his/her vote using a mobile phone, if the voter comes to a polling place to vote again after completing voting using the mobile phone, or if the voter is attempting to vote using the mobile phone after already having cast his/her vote at a polling place (S640).

The e-voting device transmits an encryption key according to the encryption method after verifying the identity of the voter and checks whether the voter attempts to vote more than once and the voter selects the encryption key (S650).

After sending the encryption keys, the e-voting device transmits vote information containing a list of possible voting selections and/or supplemental information about the vote to the voter, and the voter casts his/her vote based on the vote information which the wireless terminal receives (S660).

When the voter completes voting, the wireless terminal encrypts the content of voting and transmits it to the e-voting device, and the e-voting device stores the encrypted content of voting (S670).

When the voting time has passed, the e-voting device decrypts the stored encrypted content of voting and checks the voting selection to count the vote (S680).

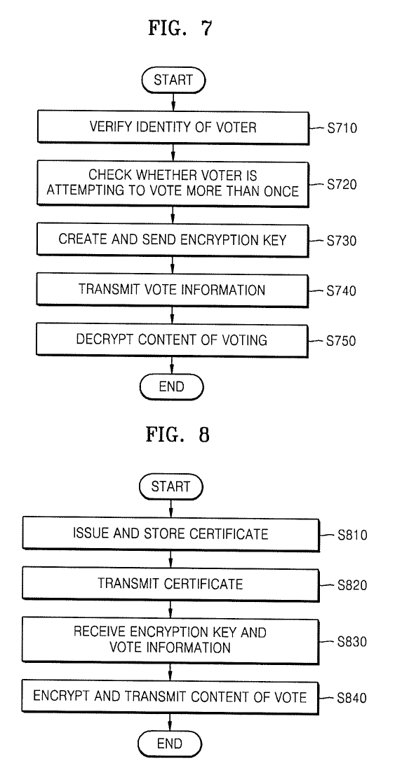

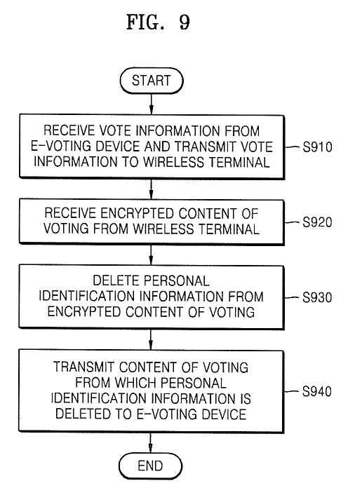

FIG. 7 is a flowchart showing the procedure of e-voting in an e-voting device according to an embodiment of the present invention, FIG. 8 is a flowchart showing the procedure of e-voting in a wireless terminal according to an embodiment of the present invention, and FIG. 9 is a flowchart showing the procedure of e-voting in a mobile communication server according to an embodiment of the present invention.

Referring to FIG. 7, the e-voting device verifies the identity of a voter based on a certificate of the voter received from the wireless terminal of the voter over a mobile communication network (S710). Before commencing the e-voting procedure, the certificate should be issued to the wireless terminal of the voter through a certification authority which has connection with the e-voting device. Also, the verification of voter's identity may be performed by the e-voting device directly or by an external certification authority connected to the e-voting device.

Once the identity of the voter is verified, it is checked if the wireless terminal is re-accessing the e-voting device after the voter completes voting, or if the voter is attempting to vote more than once by voting in person and through e-voting (S720). To this end, the e-voting device may be electronically engaged with the electoral register.

After verifying the voter's identity and checking whether the voter is attempting to vote more than once, the e-voting device generates an encryption key for encrypting the content of voting according to the encryption method and transmits it to the wireless terminal (S730). That is, in the case of a secret key encryption method, the e-voting device may generate and transmit a secret key and a key identifier, or in the case of a public key encryption method, the e-voting device may transmit its public key. In the secret key encryption method, the secret key may be created on a time period basis, or based on localities by checking the registered address in personal identification information of the voter's certificate.

Then, the e-voting device transmits vote information including the list of possible voting selections to the wireless terminal (S740). The vote information may include a list of all candidates of the whole country and the voter may select information about a candidate group of the district where the voter is registered to vote from the vote information, or include only the candidates for the district where the voter is registered to vote according to the voter's registered address in the certificate of the voter. That is, individual displays which have different vote information may be provided according to personal identification numbers of certificates which the voters send.

When receiving the content of voting that the voter made based on the vote information, the e-voting device stores the content of voting, and decrypts the stored content of voting using a corresponding key according to the encryption method to check the voting selection when the voting time has passed (S750).

Referring to FIG. 8, prior to e-voting, the wireless terminal receives a certificate issued from an external certification authority or a certification authority connected to an e-voting device and stores the certificate, or is connected to an individual storage device that stores the certificate (S810).

To commence e-voting, the wireless terminal gets access to the e-voting device, receives an identity verifying request from the e-voting device, and transmits a password which has just been entered by the voter together with the certificate of the voter to the e-voting device in response to the request in order to get the right to vote by being verified the voter's identify (S820).

Once the identity of the voter is verified, the voter is authorized to vote and the wireless terminal receives an encryption key and vote information containing the list of possible voting selections from the e-voting device (S830). The vote information may be election/vote information which can be varied for voters according to personal identification numbers.

The content of voting that the voter made based on the vote information is encrypted using the encryption key and transmitted to the e-voting device (S840).

Referring to FIG. 9, the mobile communication server receives an encryption key and the vote information containing a list of possible voting selections from the e-voting device, and transmits them to the wireless terminal (S910).

The mobile communication server receives the encrypted content of voting that the voter made based on the vote information from the wireless terminal (S920).

Personal identification information of the voter who is a user of the wireless terminal is deleted from the encrypted content of voting (S930). Therefore, the e-voting device can be aware of only the voting selection and not the identity of the voter, thereby ensuring anonymity and secrecy of the voting.

The encrypted content of voting from which the personal identification information of the voter has been deleted is sent together with a key identifier to the e-voting device (S940).

As described above, the present invention enables a voter to cast his/her vote using his/her mobile phone on a voting day without additionally registering him/herself for voting in advance and going to a polling place. Also, proxy vote or double voting is not possible, a mobile communication server, except an e-voting device, is not able to know the voting selection because the content of voting is encrypted, and the e-voting device can only know the voting selection and not identity information of the voter, and thus secrecy is ensured.

According to the present invention, a device for and a method of e-voting are provided to allow a voter to cast his/her vote more easily and conveniently than in conventional e-voting which is performed on the Internet, within the fixed time period even when the voter is not able to access the Internet on a voting day because the present invention uses a mobile terminal and a mobile communication network. Thus, the present invention can reduce time and travel demands of voting, thereby increasing the voting rate.

Also, the present invention does not need secret numbers or access numbers for the electoral register which are required for the Internet voting, and a voter who is a user of a mobile phone does not need to register separately for the e-voting before casting his/her vote and can be identified using a certificate, thereby being enabled to vote easily.

Moreover, since the content of voting is encrypted and transmitted to an e-voting device, confidentiality is ensured from a mobile communication network. In addition, since the deletion of personal identification information of the voter is made in a mobile communication server, the e-voting device cannot know the relation between the voter and the voting selection, and thus anonymity of the voter is secured.

Furthermore, only an e-voting device which knows a key to decrypt an encrypted content of voting is allowed to check the voting selection, and counting the votes using the e-voting device takes less time than when the votes are counted by hand.

The present invention may be employed not only to presidential elections, and referendums, but also to any national authority related votes such as an election of the National assembly or a local election which are required the certificate and address verification of the voter in conjunction with an address management system of national authorities.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electronic voting (e-voting) device comprising:
a voter identity verifying unit which verifies a voter can be allowed to vote based on a certificate of the voter received from a wireless terminal of the voter over a mobile communication network;
an encryption key management unit which creates an encryption key for encrypting the content of voting and transmits the encryption key to the wireless terminal;
a vote information providing unit which provides vote information containing a list of possible voting selections to the wireless terminal; and
a voting selection storing unit which decrypts the encrypted content of voting that a personal identification information of the voter has been deleted, and stores its result.

2. The e-voting device of claim 1, further comprising:
a double-voting prevention unit which refuses an attempt by the voter to re-access the e-voting device after completing e-voting and vote more than once on-line or off-line.

3. The e-voting device of claim 1, further comprising:
an external connection unit which is connected to a certification authority and transmits the certificate of the voter to the wireless terminal, the certification authority having issued, prior to the e-voting, the certificate of the voter containing a personal identification number.

4. The e-voting device of claim 1, wherein the encryption key management unit creates a secret key and a key identifier and sends them to the wireless terminal in the case of a symmetry key based method, or sends a public key of the e-voting device in the case of a public key based method, and extracts the secret key or the public key when the encrypted content of voting is decrypted.

5. The e-voting device of claim 4, wherein the encryption key management unit creates a secret key on a time period basis, or on a locality basis by checking a registered address from the certificate of the voter in the case of a symmetry key based method, and sends it to the wireless terminal.

6. The e-voting device of claim 1, wherein the vote information providing unit provides vote information containing a list of all candidates, allowing the voter to select information about a candidate group of the voter's corresponding region, or provides vote information about a candidate group of the voter's corresponding region after checking a registered address of the voter.

7. The e-voting device of claim 1, wherein the personal identification information is deleted by a mobile communication server.

8. The e-voting device of claim 1, wherein the voter identity verifying unit verifies the voter can be allowed to vote in conjunction with a certification authority.

9. An e-voting method comprising:
verifying a voter can be allowed to vote based on a certificate of the voter received from a wireless terminal of the voter over a mobile communication network;
creating an encryption key for encrypting a content of voting and sending the encryption key to the wireless terminal;
sending vote information containing a list of possible voting selections to the wireless terminal; and
decrypting the encrypted content of voting that a personal identification information of the voter has been deleted and storing its result.

10. The e-voting method of claim 9, further comprising:
refusing an attempt by the voter to re-access an e-voting device after completing e-voting and vote more than once on-line or off-line.

11. The e-voting method of claim 9, further comprising:
issuing the certificate which contains a personal identification number of the voter to the wireless terminal before verifying the voter.

12. The e-voting method of claim 9, wherein in the creating and sending of the encryption key, a secret key and a key identifier are created and sent to the wireless terminal in the case of a symmetry key based method, or a public key of the e-voting device is sent to the wireless terminal in the case of a public key based method.

13. The e-voting method of claim 12, wherein the secret key is created on a time period basis, or on a locality basis by checking a registered address from the certificate of the voter in the case of a symmetry key based method.

14. The e-voting method of claim 9, wherein in the sending of the vote information, vote information containing a list of all candidates is provided, allowing the voter to select information about a candidate group of the voter's corresponding region, or vote information about a candidate group of the voter's corresponding region is provided after checking a registered address of the voter.

15. The e-voting method of claim 9, wherein the personal identification information of the voter is deleted by a mobile communication server.

16. A wireless terminal which is connected to an e-voting device over a mobile communication network, the wireless terminal comprising:
a certificate management unit which stores a certificate of a voter containing a personal identification number and sends the certificate together with a password for the certificate which the voter has been requested to input in response to a voter verification request of the e-voting device;
a vote information receiving unit which receives vote information including an encryption key and a list of possible voting selections from the e-voting device; and
an encryption unit which encrypts the content of voting including a voting selection that a voter made based on the vote information using the encryption key and sends the encrypted content of voting to the e-voting device.

17. A method of e-voting using a wireless terminal which is connected to an e-voting device over a mobile communication network, the method comprising:
sending a certificate of a voter containing a personal identification number together with a password for the certificate which the voter has been requested to input in response to a voter verification request of the e-voting device;
receiving vote information which includes an encryption key and a list of possible voting selections from the e-voting device; and
encrypting the content of voting which includes a voting selection that a voter made based on the vote information, and sending the content of voting to the e-voting device.

18. A mobile communication server which connects a wireless terminal and an e-voting device over a mobile communication network, the mobile communication server comprising:
a sending/receiving unit which receives vote information containing an encryption key and a list of possible voting selections from the e-voting device and sends the vote information to the wireless terminal, and receives, from the wireless terminal, an encrypted content of voting which includes a voting selection that a voter made based on the vote information, and sends the encrypted content of voting to the e-voting device; and
a personal identification information deleting unit which deletes personal identification information of the voter, who cast a vote using the wireless terminal, before sending the encrypted content of voting to the e-voting device.

19. A method of e-voting using a mobile communication server which connects a wireless terminal and an e-voting device each other over a mobile communication network, the method comprising:
receiving vote information containing an encryption key and a list of possible voting selections from the e-voting device and sending the vote information to the wireless terminal;
receiving an encrypted content of voting which includes a voting selection that a voter made based on the vote information from the wireless terminal;
deleting personal identification information of the voter, who cast his/her vote using the wireless terminal, from the encrypted content of voting; and
sending the encrypted content of voting from which the personal identification information has been deleted to the e-voting device.

20. A system for e-voting over a mobile communication network, the system comprising:
a wireless terminal which encrypts a content of voting, the content of voting including a voting selection that a voter made based on received vote information, using an encryption key and sends the content of voting to a mobile communication server;
the mobile communication server which deletes personal identification information of the voter from the encrypted content of voting; and
an e-voting device which verifies the voter can be allowed to vote using a certificate of the voter and a password for the certificate which the voter has been requested to input which are received from the wireless terminal, sends the vote information and the encryption key to the wireless terminal, decrypts the encrypted content of voting from which the personal identification information has been deleted, and refuses an attempt by the voter to vote more than once.
